(19) United States
(12) Patent Application Publication
(10) Pub. No.: US 2020/0349621 A1
(43) Pub. Date: Nov. 5, 2020

(54) METHOD, SYSTEM AND COMPUTER IMPLEMENTED EVALUATION OF ELECTRONIC TRANSACTIONS

(71) Applicant: YOURPAY ApS, Rødovre (DK)

(72) Inventor: Mathias Røntved Gajhede, Nykøbing F (DK)

(21) Appl. No.: 16/642,890

(22) PCT Filed: Aug. 29, 2018
(86) PCT No.: PCT/DK2018/050211

§ 371 Date: Feb. 27, 2020

(30) Foreign Application Priority Data
Aug. 29, 2017 (DK) PA 2017 70647

(51) Int. Cl. G06Q 30/06

(52) U.S. Cl. CPC G06Q 30/0609

(57) ABSTRACT

Disclosed is a method of estimating likelihood of an alleged purchaser being the rightful purchaser in an ongoing electronic commerce transaction between a merchant and the alleged purchaser. The transaction is based on a digital identifier. The method may comprise the following computer implemented acts. There may be an act of providing electronically registered data of the rightful purchaser associated with the digital identifier. There may be an act of collecting electronically registered data of the alleged purchaser using the digital identifier in the transaction. There may be an act of estimating the likelihood as a function of the collected electronically registered data of the alleged purchaser and the provided electronically registered data of the rightful purchaser.

### FIELD OF INVENTION

This invention relates to a method of estimating likelihood of an alleged purchaser being the rightful purchaser in an ongoing electronic commerce transaction between a merchant and the alleged purchaser. The transaction is based on a digital identifier. The method may comprise the following computer implemented acts. There may be an act of providing electronically registered data of the rightful purchaser associated with the digital identifier. There may be an act of collecting electronically registered data of the alleged purchaser using the digital identifier in the transaction. There may be an act of estimating the likelihood as a function of the collected electronically registered data of the alleged purchaser and the provided electronically registered data of the rightful purchaser.

### BACKGROUND OF THE INVENTION

Electronic transactions between a purchaser and a merchant requires verification of the purchaser being the rightful or authorised user of a digital identifier e.g. a credit card number, provide as a link to an underlying security.

Increased use of electronic transactions, increased fraud and counter mechanisms has created a need for a more robust and precise method or system to ensure reliable use of electronic transactions. This is not only to prevent fraud, but also to allow an authorised person to rightfully perform purchases or transactions, which transactions would have been rejected using systems known to now.

US20160063500 describes a method for automated acceptance of payment of transactions that have been flagged for human review by an anti-fraud system. The method collects electronically registered data about the alleged purchaser, which the method compares to registered data about the rightful purchaser and a likelihood of the alleged purchaser being the rightful purchaser is estimated. However, the first step in the method is an estimation of the alleged purchaser and rightful purchaser based on static rules. This may result in a rightful purchaser being flagged as a high risk transaction, where the transaction is rejected without an automated review process. If a credit card is used in two different locations far apart within a short period of time i.e. Copenhagen and Berlin, then the rule based system will flag the transaction as a high risk and the transaction is rejected.

Furthermore, the method disclosed in US20160063500 only limits the number of transactions for manual review as 2% of all transactions are checked manually. This is a very high number of transactions and thus, there is a need for a completely automated method and system for estimating the likelihood of an alleged purchaser being the rightful purchaser in an on-going electronic commerce transaction.

### OBJECT OF THE INVENTION

It is an objective of this invention to overcome limitations of the prior art systems. In particular it is an objective to provide methods and systems that can provide a more reliable and robust way of determining if the purchaser in an ongoing electronic transaction is the rightful or authorised purchaser. In an aspect it is an objective to provide a method or system that will not reject a rightful or authorised purchaser.

Part of such evaluation is an authentication, where authentication is the process of validating the identity of a purchaser or consumer prior to completing the purchase.

It is a further objective to improve placement of liability or shift of risk between a merchant and a principal (card acquirer).

### DESCRIPTION

An object of the invention is achieved by a method of estimating likelihood of an alleged purchaser being the rightful purchaser in an ongoing electronic commerce transaction between a merchant and the alleged purchaser. The transaction is based on a digital identifier.

The method may comprise the following computer implemented acts.

There may be an act of providing electronically registered data of the rightful purchaser associated with the digital identifier.

There may be an act of collecting electronically registered data of the alleged purchaser using the digital identifier in the transaction.

There may be an act of estimating the likelihood as a function of the collected electronically registered data of the alleged purchaser and the provided electronically registered data of the rightful purchaser.

Such method or methodology will allow transactions that in reality are valid, but otherwise established or evaluated to be invalid or even fraud to be further assessed or evaluated. In short, the method allows for an improved assessment or evaluation of the likelihood of the alleged purchaser being the right purchaser. The method may reduce or eliminate false classifications of a transaction to be invalid or reduce or eliminate false negatives.

The method or methodology may improve or clarify the placement or shift of risk in electronic commerce transactions between a merchant and a principal e.g. a card acquirer.

Card Scheme: Card schemes are payment networks linked to payment cards, such as debit or credit cards, of which a bank or any other eligible financial institution can become a member. By becoming a member of the scheme, the member then gets the possibility to issue or acquire cards operating on the network of that card scheme.

Card Acquirer: An acquiring bank (also known simply as an acquirer) is a bank or financial institution that processes credit or debit card payments on behalf of a merchant. The acquirer allows merchants to accept credit card payments from the card-issuing banks within an association.

Payment Service Processor/Payment Gateway: A payment service provider (PSP) offers shops online services for accepting electronic payments by a variety of payment methods including credit card, bank-based payments such as direct debit, bank transfer, and real-time bank transfer based on online banking.

Merchant: The merchant may be the company or retailer selling services or products. The merchant may be a bank, a person or generally a recipient of e.g. valuable consideration.

Merchant Account: A merchant account is a type of bank account that allows businesses to accept payments in multiple ways, typically debit or credit cards. A merchant account is established under an agreement between an acceptor and a merchant acquiring bank for the settlement of payment card transactions.

The “digital identifier” may be a credit card (cc), a bank account number, social profiles, account related data, digital footprints, analogue footprints, forum registrations, signups at campaigns, open e-mails, attachments, open documents, tails, traces, information transmitted, videos, digital images.

The rightful purchaser is the owner of the assets associated with the digital identifier. In the case of the digital identifier being a credit card (number), the owner of the credit card or anyone being authorised to use the credit card is the rightful purchaser. The rightful purchaser should be an authentic purchaser.

The alleged purchaser is the user of the digital identifier in the ongoing transaction e.g. in a web-based transaction between a customer and a merchant, the alleged purchaser is the “purchasing activity” observed during use of the credit card. The alleged purchaser and the rightful purchaser may be assumed to be the same (physical) person; until proven otherwise.

The likelihood may be used for authentication, where authentication is the process of validating the identity of a purchaser or consumer prior to completing the purchase.

In an aspect, the act of collecting may include an act of requesting data based on the electronically registered data of the rightful purchaser from the alleged purchaser.

The act of requesting may be in the form of a question, which is known to the rightful purchaser.

The question may be a request for the rightful purchaser's social security number, i.e. data which is or should not publicly available.

The question may be a request for the rightful purchaser's birthday, i.e. data which is publicly available.

The act of requesting may be in the form of linking to a third party authentication service such as a national electronic ID (NemID in Denmark) or Visa Verification Service.

The act of requesting may be in the form of sending the rightful purchaser an e-mail and/or SMS with an authentication code and requesting the authentication code from the alleged purchaser.

In an aspect, the acts of collecting and estimating is performed iteratively one or more times during which iterations, the likelihood is partitioned as follows.

There is a partition of the likelihood, where the transaction is for acceptance. That is where the alleged purchaser is the rightful purchaser and the iterations are stopped.

There is a partition of the likelihood where the transaction is for re-evaluation. That is where the alleged purchaser is assumed to be the rightful purchaser and the iterations are continued.

There is a partition of the likelihood where the transaction is considered inconclusive. That is where the alleged purchaser cannot be determined to be the rightful purchaser and the iterations are stopped.

When the transition is “set for acceptance”, the alleged purchaser is considered the rightful purchaser.

When the transition is for re-evaluation or for review, the method does not consider the transaction to be fraud or invalid by assuming that the alleged purchaser is not the rightful purchaser. Rather the method works on the hypothesis that the alleged purchaser is the rightful purchaser, and attempts to establish the hypothesis. Hence a transaction that is otherwise considered fraud or invalid may by collection of (more) data be found to be a valid transaction. In short the method attempts to be able to positively, or with certain likelihood, establish that the alleged purchaser is in fact the rightful purchaser.

When the transaction is considered inconclusive or “un-evaluated”, the method may not have reached a result that adds more information to the ongoing transaction. In this partition, the transaction may be valid or the transaction may be fraud.

In an aspect, the likelihood may only be partitioned as inconclusive, when the ongoing electronic commerce transaction is cancelled before the likelihood is partitioned for acceptance.

Thus, the method may continuously re-iterate the steps of collecting and estimating until the alleged purchaser is proven to be the rightful purchaser.

The method may continuously request data based on the electronically registered data of the rightful purchaser from the alleged purchaser until it is proven by the alleged purchaser that the alleged purchaser is the rightful purchaser, or until the ongoing electronic commerce transaction between the merchant and the alleged purchaser is cancelled. In this case the likelihood is partitioned as inconclusive.

The ongoing electronic commerce transaction may be cancelled by the alleged purchaser if the alleged purchaser gives up after the first re-iteration, fifth re-iteration, 1000^{th} re-iteration or an even higher re-iteration.

The overall advantage is that the method allows a transaction considered valid or verified by a card scheme, may be further assessed by using or applying the outlined method. In particular the method of estimating the likelihood can be used to re-evaluate transactions otherwise considered to fraud. If a transaction is deemed to be fraud, the method may rather than rejecting the transaction place the transaction for review and to further receive data from or about the rightful purchaser or/and collect data from or about the alleged purchaser to attempt to make the alleged purchaser be identified. This identification may involve crawling after more data or information about the rightful and alleged purchaser and to compare or evaluate the data.

| | Verified | Un-verified |
|---|---|---|
| Transaction for acceptance/accepted | X | |
| Transaction for re-evaluation/for review | X | X |
| Transaction inconclusive/un-evaluated | | X |

In an aspect, the act of collecting electronically registered data includes collecting digital identifier-DNA. The term DNA refers to a unique footprint, pattern or other uniqueness associated with a personal identifier e.g. a social security number, a driving licence number, electronic device id, IMEI, SIM-card identification or alike.

Such information or data may further complete the picture of the user and be used as a basis for collecting data. The digital identifier-DNA or personal identifier may be a link to additional data available based on the personal identifier.

In association with providing the digital identifier-DNA there may be an authorisation to collect information or data based on the digital identifier-DNA.

In an aspect, the act of collecting electronically registered data includes collection of a person-browser-DNA of the alleged purchaser, a software implemented interface-browser-DNA used by the alleged purchaser or collecting both.

The “browser” may be a person who “browses the net” in a particular and distinctive way or pattern. The person may type with a particular typing-pattern thereby leaving a trace of typing-pattern. Such trace or pattern may be the periodicity of strokes, use of certain words, phrases, aberrations or peculiarities.

In an aspect, the collection of person- and/or interface-browser-DNA includes collecting one or more browser-setting(s) or browser-pattern(s).

The “browser” may also be a “software implemented interface” used to browse the internet. The interface-browser-DNA may be a particular browser type e.g. Chrome, etc. or settings of the interface-browser e.g. font type settings, language preference, cookies settings etc.

In an aspect, one or more acts are performed if the digital identifier is known (to the system); the acts comprising one or more of the following acts of evaluating if the transaction is likely based on stored historical transactions performed by the rightful purchaser. The act may be estimating the likelihood based on stored historical transactions previously performed by the rightful purchaser.

In an aspect, one or more acts are performed if the digital identifier is known. The acts comprising one or more of the following acts of updating electronically registered data of the rightful purchaser associated with the digital identifier. The updated data may be collected from updated status data of the rightful purchaser.

The digital identifier may be known or available from a digital storage or database. There may be data or electronically registered data associated with the digital identifier. In that case new or additional data collected may be used to update the electronically registered data associated with the known identifier.

In an aspect, the act of updating electronically registered data of the rightful purchaser is sourced from personal data sources of the rightful purchaser.

Personal data sources may include social networks and status updates on such. Another source may be a public calendar from which information about whereabouts is retrieved. Another source may be a mobile device with location data about whereabouts. Another source may be a blog or a news site containing information about the rightful purchaser.

Using data from such sources may increase the validity of the registered data and improve the estimation of likelihood.

Retrieving or collecting the data may be performed by implementation of crawling algorithms. In cases and when needed authorisation may be provided by the person.

In an aspect, one or more acts are performed if the digital identifier is unknown. The acts comprising one or more of the following acts of updating electronically registered data of the rightful purchaser associated with the digital identifier.

When the digital identifier is unknown e.g. used for the first time simply for the first time in connection with the methodology, there may be acts of multiple collections of data. There may be an algorithm activated to source several sources and the sources may be deep requiring the algorithm or crawler to “dig” through layers of data sources.

As an example if a digital identifier is not registered through the platform, the consumer's credit card name is used across internet search services, to find any available data about the rightful purchaser. Through online portals with available search functionality, we do request all known data connected with the rightful purchasers name and the data is updated to the electronically data of the rightful.

Collection of such data may require further processing to extract and phrase the data.

In an aspect, the act of updating electronically registered data of the rightful purchaser is sourced from officially registered data sources linking a personal identification number to the rightful purchaser.

The rightful purchaser may have a personal identification number such as a social security number, a driving license or a unique identifier linking the person to officially registered information in officially registered data sources. Such data sources may be driving licence registers, property registers, and credit ranking registers. There may also be data sources from other governmental registers including Inland Revenue (i.e. TAX) authorities and even health and social registers may provide information that can increase quality of the estimation of likelihood.

In an aspect, the act of updating electronically registered data of the rightful purchaser is sourced from one or more publicly available data source(s).

The sources may be one or more sources chosen amongst social network status updates, news and blogs, calendar(s) or mobile devices with location data.

An object is achieved by a method of performing an electronic commerce transaction between a merchant and alleged purchaser wherein the transaction is based on a digital identifier linked to a principal verifying the transaction for completion by the merchant. The method may comprise the following acts.

Initially, the alleged purchaser optionally directly or via the merchant passes the digital identifier to a system for estimating likelihood of an alleged purchaser being the rightful purchaser in the ongoing electronic commerce transaction. This system may be nicknamed “Albert”.

The system is configured to perform actions and in the system for estimating likelihood acts are performed as follows.

The system is registering the digital identifier and the transaction and providing electronically registered data of the rightful purchaser associated with the digital identifier.

The system is collecting electronically registered data of the alleged purchaser using the digital identifier in the transaction.

The system is estimating the likelihood as a function of the collected electronically registered data of the alleged purchaser and the provided electronically registered data of the rightful purchaser.

To perform the above actions, the system for estimating likelihood is configured for passing the digital identifier and the transaction to the principal for verification of the transaction based on the digital identifier. Likewise, the system for estimating likelihood is being configured for receiving a “transaction verified” or a “transaction un-verified” from the principal.

When the system has received “transaction verified”, the system for estimating likelihood performs acts of transaction confirmation and storage of that the alleged purchasers digital footprint matches the identification of the rightful purchaser.

When the system has received “transaction un-verified” i.e. transaction risk identified, the system for estimating likelihood performs acts of marking the alleged purchaser's transaction for automated review, where the consumer may be asked known sourced data from the rightful purchaser. The sourced data may contain person-related data as to the rightful purchaser.

Finally the system for estimating likelihood passes the estimated likelihood and the likelihood partitioned as “Transaction is for acceptance”, “Transaction is for re-evaluation”, or “Transaction is considered inconclusive” to the merchant and conditionally one or more verification requirements for the transaction to proceed or not.

In an aspect, the system for estimating the likelihood is implemented as instructions on a computer to perform one or more actions of the method disclosed.

An object is achieved by a system for estimating likelihood of an alleged purchaser being the rightful purchaser in an ongoing electronic commerce transaction between a merchant and the alleged purchaser. The transaction being based on a digital identifier, and the system may comprise or be configured with the following features.

There is a merchant interface to exchange data with a merchant. There is a principal interface to exchange data with a principal. There is a collection interface for providing electronically registered data of the rightful purchaser associated with the digital identifier and collecting electronically registered data of the alleged purchaser using the digital identifier in the transaction.

There is a computer configured for estimating the likelihood as a function of the collected electronically registered data of the alleged purchaser and the provided electronically registered data of the rightful purchaser.

The above disclosed acts may be implemented as a computer program comprising instructions to cause the computer to execute the methods or actions.

In an embodiment a computer-readable medium comprising instructions which, when executed by a computer, cause the computer to carry out the method and/or actions.

In another embodiment of the method of performing an ongoing electronic commerce transaction between a merchant and an alleged purchaser wherein the transaction is based on a digital identifier linked to a principal verifying the transaction for completion by the merchant.

The method may comprise the following acts.

Initially, the alleged purchaser optionally directly or via the merchant passes the digital identifier to a system for estimating likelihood of an alleged purchaser being the rightful purchaser in the ongoing electronic commerce transaction. The system may be nicknamed “Albert”.

The system may be configured to perform actions and in the system for estimating likelihood acts are performed as follows.

The system may be registering the digital identifier and the transaction.

The system may be providing electronically registered data of the rightful purchaser associated with the digital identifier.

The system may be collecting electronically registered data of the alleged purchaser using the digital identifier in the transaction.

The system may be estimating the likelihood as a function of the collected electronically registered data of the alleged purchaser and the provided electronically registered data of the rightful purchaser.

To perform the above actions, the system for estimating likelihood may be configured for passing the digital identifier and the transaction to the principal for verification of the transaction based on the digital identifier. Likewise, the system for estimating likelihood may be configured for receiving a “transaction verified” or a “transaction un-verified” from the principal.

When the system has received “transaction verified” the likelihood of first iteration is partitioned as
Transaction is for acceptance;
Transaction is for re-evaluation;

When the system has received has received “transaction un-verified”, the likelihood is partitioned as
Transaction is for re-evaluation;
Transaction is considered inconclusive;

If the transaction is for acceptance, then the system for estimating likelihood sends a “transaction verified” to the merchant. The merchant may then accept the order.

The alleged purchaser's digital footprint related to the transaction may then be stored as the rightful purchaser's digital footprint.

If the transaction is considered inconclusive, then the system for estimating likelihood is configured to sending “transaction un-verified” to the merchant. The merchant may then cancel the order.

If the transaction is for re-evaluation, the system for estimating likelihood may perform further acts of collecting and estimating iteratively one or more times until the likelihood is partitioned as either
Transaction is for acceptance;
Transaction is considered inconclusive.

When the transaction is for re-evaluation, the alleged purchaser may be asked known sourced data from the rightful purchaser. The sourced data may contain person-related data as to the rightful purchaser.

The alleged purchaser may be asked one or more questions and if one or more questions are answered incorrectly, there may be sent a SMS to a registered and verified number of the rightful purchaser or in another way chosen by the card issuer.

In an embodiment the alleged purchaser may be asked up to a maximum of three questions.

If the likelihood partition after a number of iterations is still transaction is for re-evaluation, then the likelihood partition is changed to transaction is considered inconclusive. Thus, the iteration is stopped.

### BRIEF DESCRIPTION OF DRAWINGS

Embodiments of the invention will be described in the figures, whereon:

FIG. 1 illustrates a flow diagram of a prior art transaction;

FIG. 2 illustrates another flow diagram of a prior art transaction;

FIG. 3 illustrates a flow diagram of a transaction using a method of performing an electronic commerce transaction;

FIG. 4 illustrates a flow diagram of a system for estimating likelihood of an alleged purchaser being the rightful purchaser;

FIG. 5 illustrates an example of an act of estimating likelihood of alleged purchaser being the rightful purchaser;

FIG. 6 illustrates a method of estimating likelihood;

FIG. 7 illustrates the likelihood iteration process;

FIG. 8 illustrates the collecting of electronically registered data of the alleged purchaser;

FIG. 9 illustrates browser-DNA;

FIG. 10 illustrates the act of estimating likelihood of alleged purchaser being the rightful purchaser based on stored historical transactions;

FIG. 11 illustrates a method of estimating likelihood, when the digital identifier is unknown;

FIG. 12 illustrates updating the electronic registered data of the rightful purchaser;

FIG. 13 illustrates the linkage to a rightful purchaser with one or more digital identifiers and one or more personal identifiers;

FIG. 14 illustrates a sample space of the method of estimating likelihood;

FIG. 15 illustrates a system for estimating likelihood;

FIG. 16 illustrates a tree of data collection and estimation;

FIG. 17 illustrates how the system registers changing behaviour of the rightful purchaser;

FIG. 18 illustrates data sources which can be used in the estimating likelihood; and

FIG. 19 illustrates the distribution of data.

| Item | No |
|---|---|
| Ongoing electronic commerce transaction | 1 |
| Purchaser | 10 |
| Alleged purchaser | 10A |
| Rightful purchaser | 10R |
| Merchant | 20 |
| Card Acquirer/Processor/Principal | 30 |
| Digital identifier/Credit Card Number | 50 |
| Digital identifier-DNA | 55 |
| Personal identifier | 57 |
| Electronically registered data | 60 |
| Electronically registered | 60A |
| data of alleged purchaser | |
| Electronically registered | 60R |
| data of rightful purchaser | |
| Personal data source(s) | 65 |
| Official registered data source(s) | 66 |
| Publicly available data source(s) | 67 |
| Person-browser-DNA | 70 |
| Interface-browser-DNA | 75 |
| Browser setting(s) | 77 |
| Browsing-pattern(s) | 78 |
| Estimating Likelihood | 100 |
| Function | 110 |
| Likelihood | 120 |
| Transaction accepted | 132 |
| Transaction is re-evaluate | 134 |
| Transaction inconclusive | 136 |
| Historical transactions | 140 |
| Providing | 200 |
| Updating | 220 |
| Collecting | 300 |
| Estimating | 400 |
| Registering | 500 |
| Passing | 600 |
| Storing | 700 |
| Requesting | 800 |
| Method of performing | 1000 |
| System for estimating likelihood | 1100 |
| A mercant interface | 1120 |
| A principal interface | 1130 |
| A collection interface | 1140 |
| Computer | 1200 |
| Computer program | 1210 |

### DETAILED DESCRIPTION OF DRAWINGS

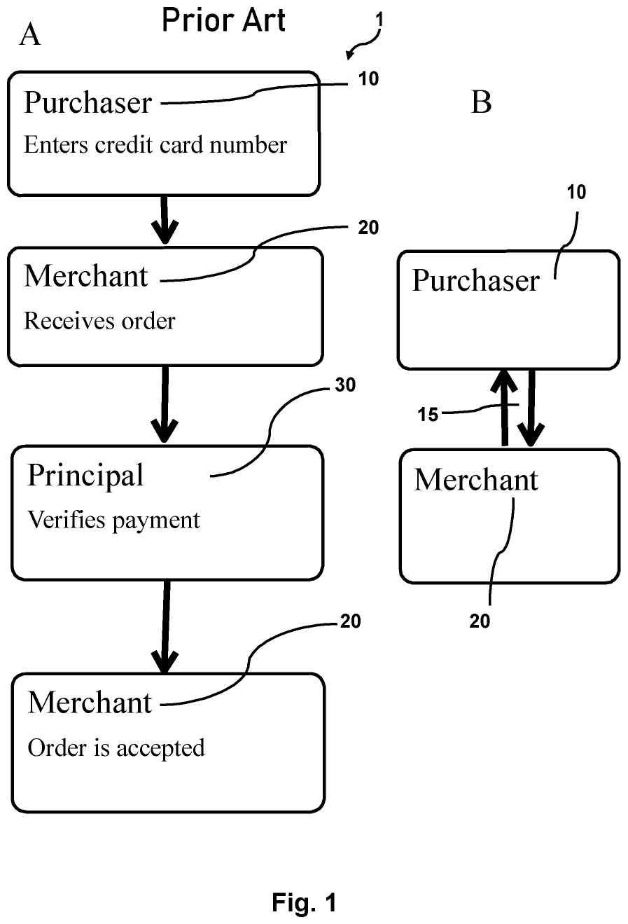

FIG. 1 illustrates a flow diagram of a prior art transaction 1. In FIG. 1A discloses an example of an electronic transaction 1 begins when a purchaser 10 enters a credit card number. A merchant 20 receives an order originating from the purchaser 10 and if the card acquirer 30 verifies the payment; the merchant 20 accepts the order.

FIG. 1B discloses a transaction 15 between a purchaser 10 and a merchant 20. The purchaser gives the order and money to the merchant 20, who provides a product or a service.

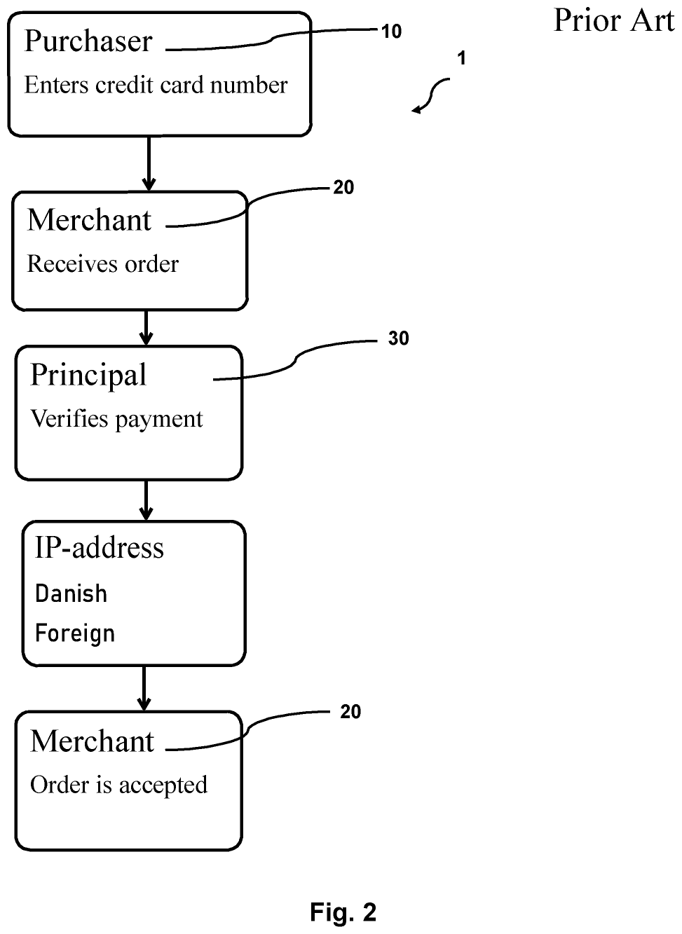

FIG. 2 illustrates another flow diagram of a prior art transaction 1. A transaction begins when a purchaser 10 enters a credit card number, after which a merchant 20 receives an order originating from the purchaser 10 and if the card acquirer 30 verifies the payment; the merchant 20 accepts the order. When the payment is being processed the location address, this can be identified through the alleged purchaser's mobile location identification, IP-address or an alternative ISP location-based data source.

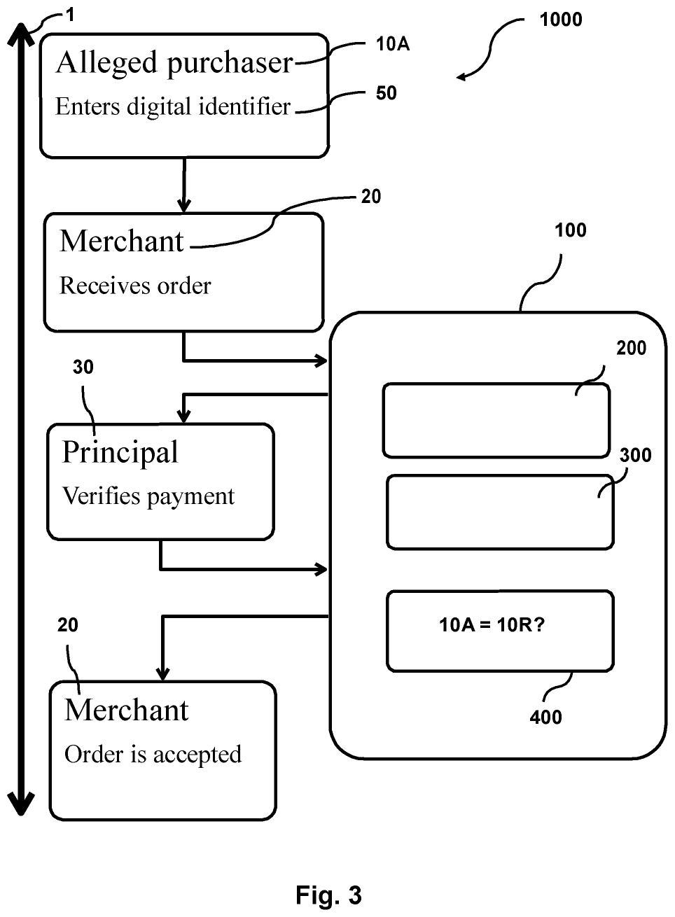

FIG. 3 illustrates a flow diagram of an ongoing electronic commerce transaction 1 using the method of performing an electronic commerce transaction 1000. The transaction 1 is started by an alleged purchaser 10A, who enters a digital identifier 50 along with placing an order. The digital identifier 50 and the order are received by a merchant 20, who exchanges data with the digital identifier 50 to a computer implemented method for estimating likelihood 100 through a merchant interface 1120 (not shown). The computer implemented method for estimating likelihood 100 performs acts of providing 200 electronically registered data 60R of the rightful purchaser 10R associated with the digital identifier 50.

The implemented method is configured for collecting 300 electronically registered data 60A of the alleged purchaser 10A using the digital identifier 50 in the transaction 1.

The implemented method is configured for providing 200 electronically registered data 60R of the rightful purchaser 10R associated with the digital identifier 50.

The implemented method is configured for collecting 300 electronically registered data 60A of the alleged purchaser 10A using the digital identifier 50 in the transaction 1.

The implemented method is configured for estimating 400 the likelihood 120 as a function 110 of the collected electronically registered data 60A of the alleged purchaser 10A and the provided electronically registered data 60R of the rightful purchaser 10R.

The computer implemented method for estimating likelihood 100 may exchange data with a principal 30 through a principal interface 1130 (not shown).

The final result of the estimation is exchanged with the merchant 20 through a merchant interface 1120, who may accept or deny the order based on the estimation.

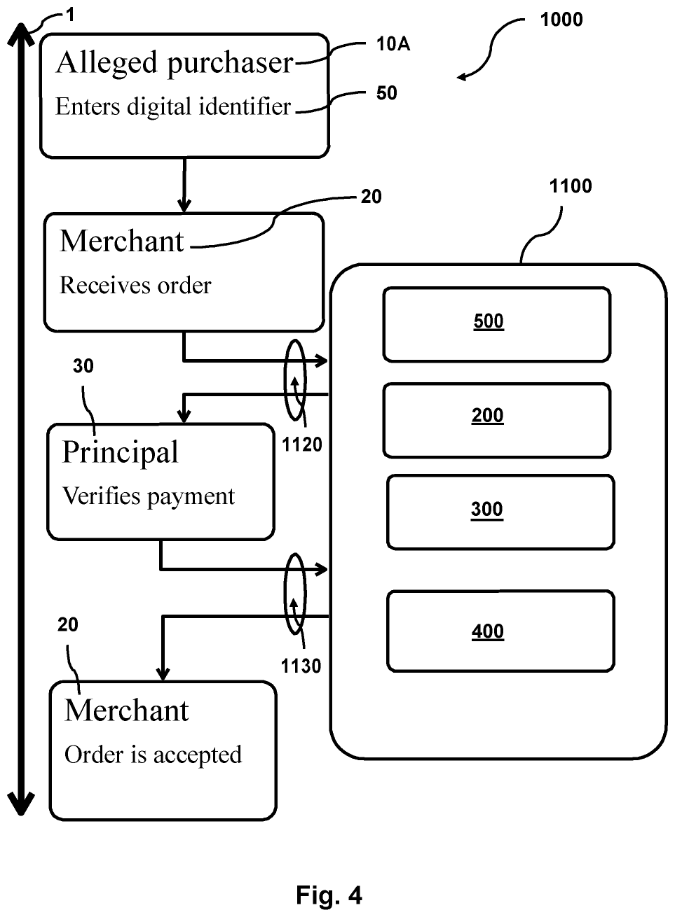

FIG. 4 illustrates a flow diagram of a system 1100 for estimating likelihood 120 of an alleged purchaser 10A being the rightful purchaser 10R in an ongoing electronic commerce transaction 1 between a merchant 20 and the alleged purchaser 10A. The transaction 1 is based on a digital identifier 50. The system 1100 comprises the following features.

There is a merchant interface 1120 to exchange data with a merchant 20. There is a principal interface 1130 to exchange data with a principal 30.

There is a collection interface 1140 for providing 200 electronically registered data 60R of the rightful purchaser 10R associated with the digital identifier 50 and collecting 300 electronically registered data 60A of the alleged purchaser 10A using the digital identifier 50 in the transaction 1.

There is a computer 1200 configured for estimating 400 the likelihood 120 as a function 110 of the collected electronically registered data 60A of the alleged purchaser 10A and the provided electronically registered data 60R of the rightful purchaser 10R.

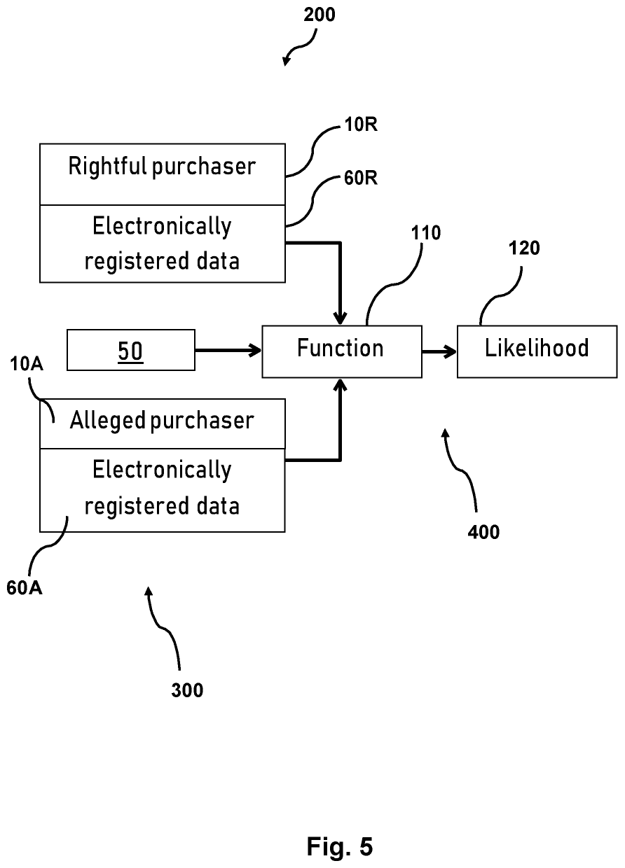

FIG. 5 illustrates an example of an act of estimating 400 the likelihood 120 of the alleged purchaser 10A being the rightful purchaser 10R. The alleged purchaser 10A uses or enters a digital identifier 50 which triggers an act of collecting 300 electronically registered data 60A of the alleged purchaser 10A, who uses the digital identifier 50 in the transaction 1. A digital identifier 50 links the alleged purchaser 10A with the rightful purchaser 10R and an act of providing 200 electronically registered data 60R of the rightful purchaser 10R associated with the digital identifier 50. What the electronically registered data 60A, 60R contain is shown in other figures. A function 110 performs an act of estimating 400 the likelihood 120 of an alleged purchaser 10A being the rightful purchaser 10R based upon the electronically registered data 60A.

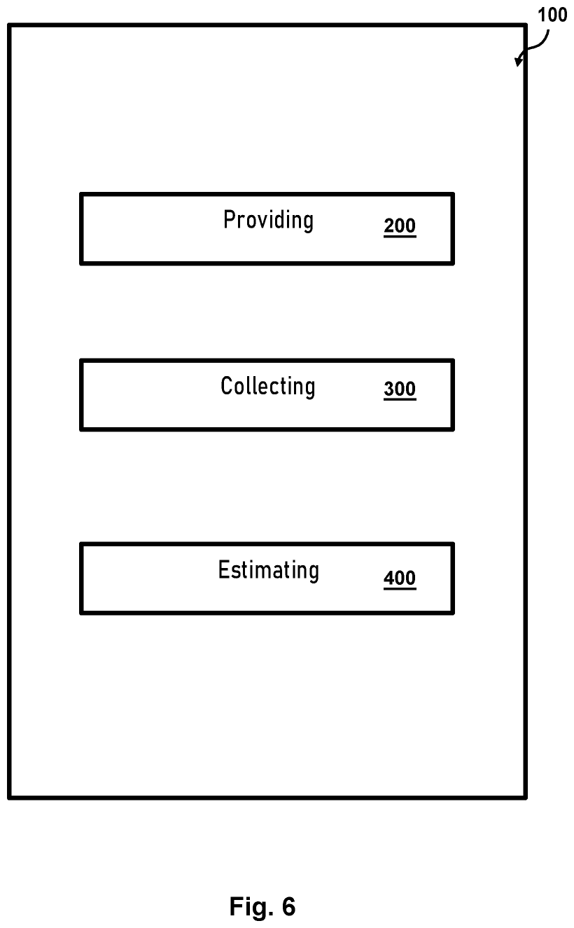

FIG. 6 illustrates a method of estimating the likelihood 100. The method of estimating likelihood 100 of an alleged purchaser 10A being the rightful purchaser 10R in an ongoing electronic commerce transaction 1 between a merchant 20 and the alleged purchaser 10A. The transaction 1 is based on a digital identifier 50; the method comprises computer implemented acts as follows.

There is an implementation for providing 200 electronically registered data 60R of the rightful purchaser 10R associated with the digital identifier 50.

There is an implementation for collecting 300 electronically registered data 60A of the alleged purchaser 10A using the digital identifier 50 in the transaction 1.

There is an implementation for estimating 400 the likelihood 120 as a function 110 of the collected electronically registered data 60A of the alleged purchaser 10A and the provided electronically registered data 60R of the rightful purchaser 10R.

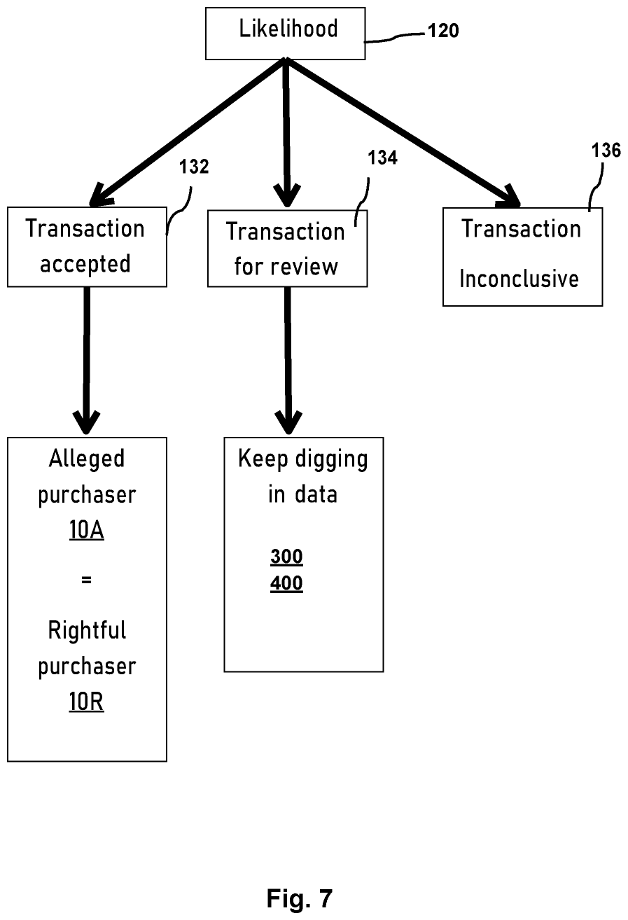

FIG. 7 illustrates the likelihood 120 iteration process. The acts of collecting 300 and estimating 400 are performed iteratively one or more times during which iterations, the likelihood 120 is partitioned as follow.

There is a partition for “Transaction is for acceptance” 132; where the alleged purchaser 10A is the rightful purchaser 10R and the iterations are stopped.

There is a partition for “Transaction is for re-evaluation” 134; where the alleged purchaser 10A is assumed to be the rightful purchaser 10R and the iterations are continued.

There is a partition for “Transaction is considered inconclusive” 136; where the alleged purchaser 10A cannot be determined to be the rightful purchaser 10R and the iterations are stopped.

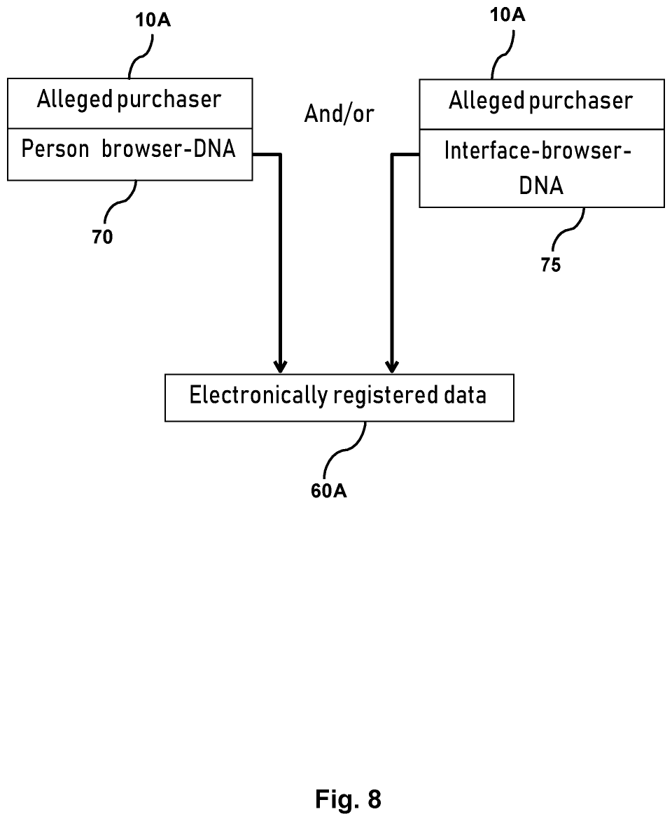

FIG. 8 illustrates the act of collecting 300 of electronically registered data 60A of the alleged purchaser 10R, which includes collection of a person-browser-DNA 70 of the alleged purchaser 10A, a software implemented interface-browser-DNA 75 used by the alleged purchaser 10A or collecting both.

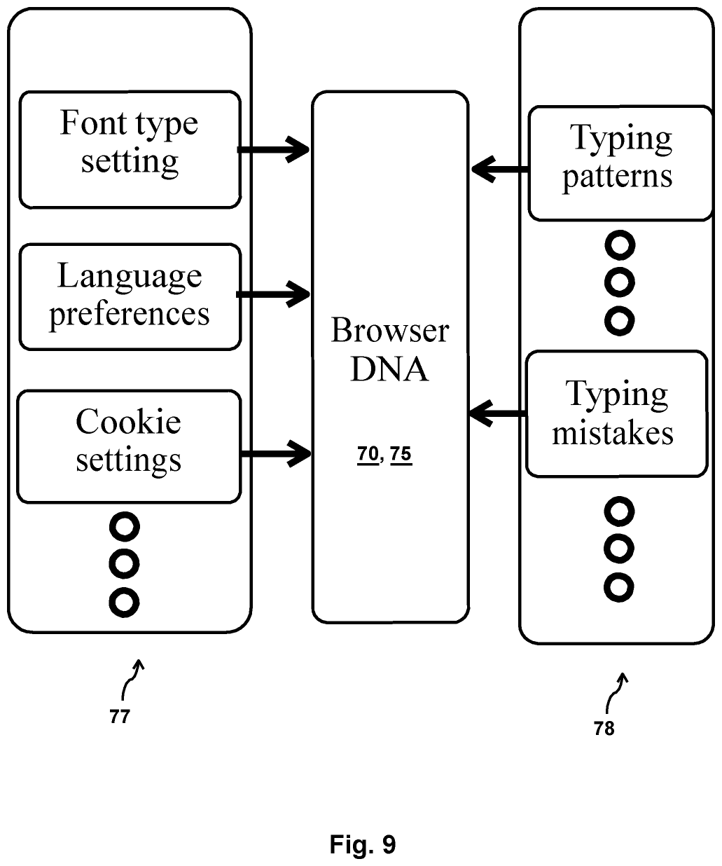

FIG. 9 illustrates browser-DNA 70, 75 which can be one or more browser settings 77 e.g. font type setting, language preferences and/or cookie settings.

In other embodiments the browser settings 77 could be browser version or browser type e.g. Safari, Firefox, Chrome, Edge, and Internet Explorer and so on.

The browser-DNA 70, 75 may also contain browser-pattern 78 such as typing patterns and/or typing mistakes.

The browser-DNA 70, 75 should not be limited to the examples mentioned above.

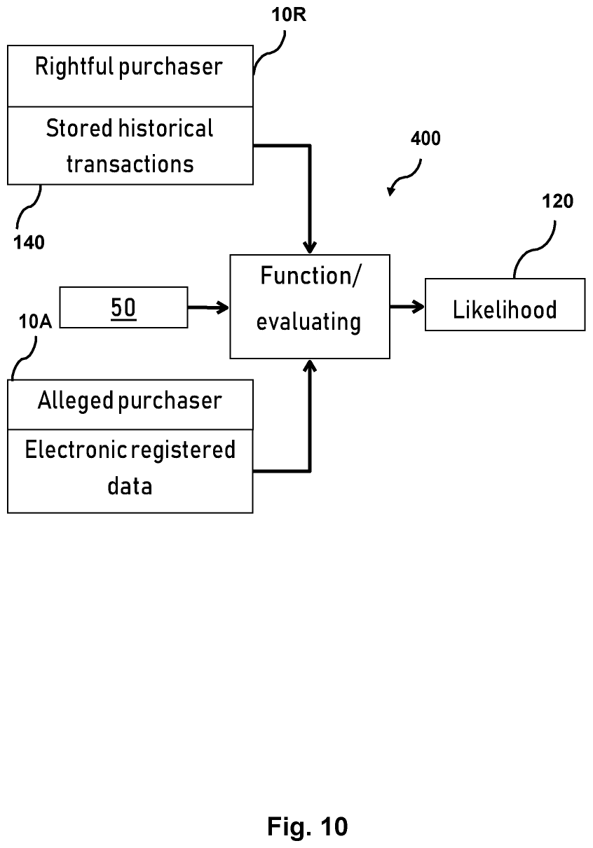

FIG. 10 illustrates the act of estimating 400 the likelihood 120 of alleged purchaser 10A being the rightful purchaser 10R based on stored historical transactions 140. What is described is only possible if the digital identifier 50 is known to the system for estimating likelihood 1100 as it relies on stored historical transactions 140.

The alleged purchaser 10A provides a digital identifier 50, which links the alleged purchaser 10A to the rightful purchaser 10R. The method may then perform one or more acts of evaluating 400 if the transaction is likely based on stored historical transactions 140 performed by the rightful purchaser 10R.

The method will provide a likelihood 120 on whether the alleged purchaser 10A is the rightful purchaser 10R.

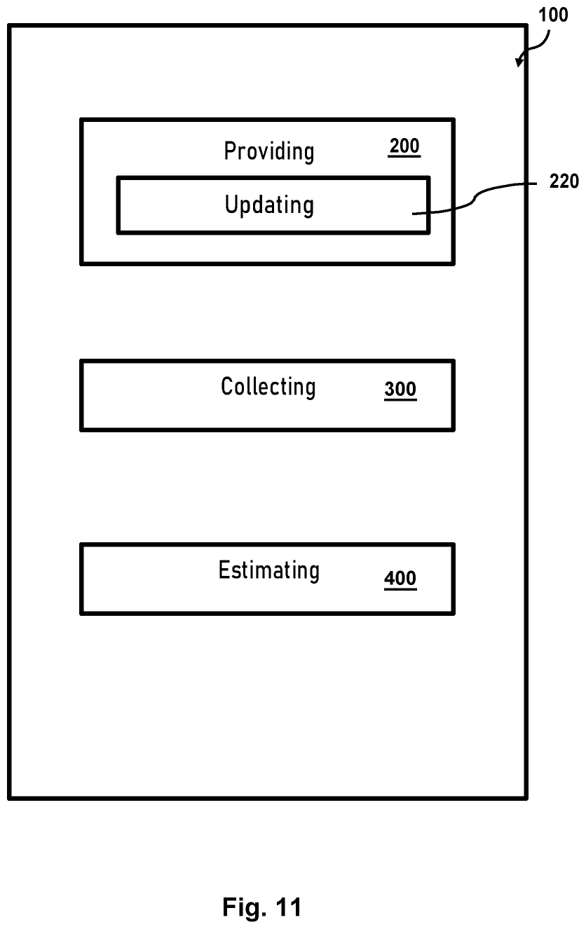

FIG. 11 illustrates a method of estimating likelihood 100, when the digital identifier 50 is unknown. The digital identifier 50 is unknown if the method of estimating likelihood 100 has not used it before.

The method of estimating likelihood 100 of an alleged purchaser 10A being the rightful purchaser 10R in an ongoing electronic commerce transaction 1 between a merchant 20 and the alleged purchaser 10A. The transaction 1 is based on a digital identifier 50, which in this case is unknown, the method comprises computer implemented acts of a follows.

There is an implementation for providing 200 electronically registered data 60R of the rightful purchaser 10R associated with the unknown digital identifier 50.

There is an implementation for updating 220 electronically registered data 60R of the rightful purchaser 10R associated with the unknown digital identifier 50.

There is an implementation for collecting 300 electronically registered data 60A of the alleged purchaser 10A using the digital identifier 50 in the transaction 1.

There is an implementation for estimating 400 the likelihood 120 as a function 110 of the collected electronically registered data 60A of the alleged purchaser 10A and the provided electronically registered data 60R of the rightful purchaser 10R.

If the alleged purchaser 10A uses an unknown digital identifier 50, which links to the rightful purchaser 10R, then the rightful purchaser 10R may not be unknown to the method or system. Thus, stored historical transaction 140 can be used in the first iteration of estimating likelihood 100.

The act of updating 220 electronically registered data 60R of the rightful purchaser 10R may be sourced from officially registered data sources 66 linking a personal identification number 57 to the rightful purchaser 10R.

The act of updating 220 electronically registered data 60R of the rightful purchaser 10R may be sourced from one or more publicly available data source(s) 67. The data sources could be LinkedIn, Facebook, Instagram, Twitter or the like.

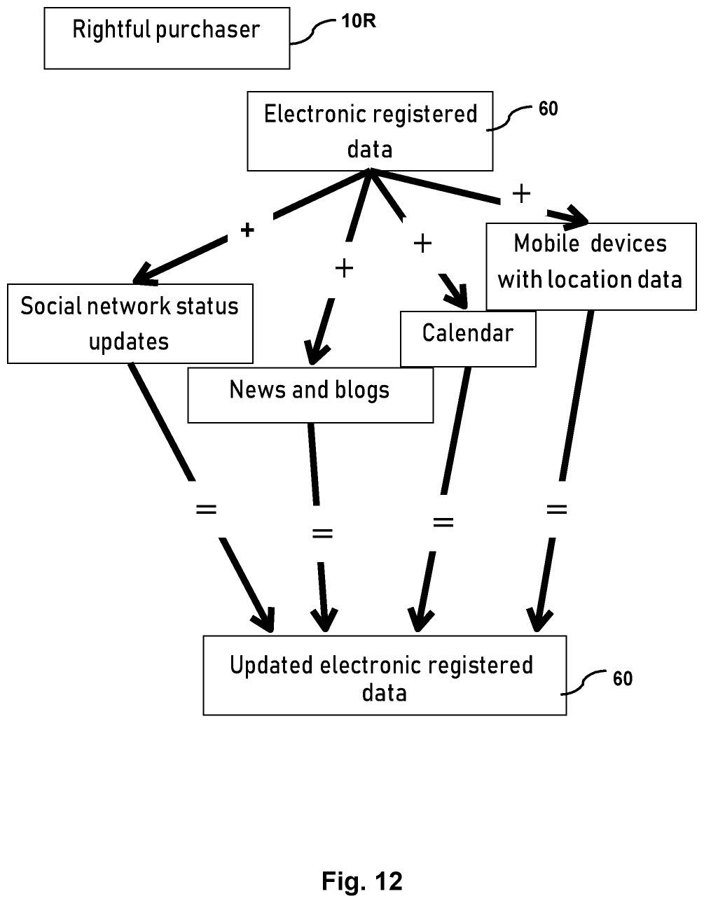

FIG. 12 illustrates updating the electronic registered data 60R of the rightful purchaser 10R. The electronic registered data 60R can be updated using social network status updates, news, blogs, calendar, mobile devices with location data.

The act of updating 220 electronically registered data 60R of the rightful purchaser 10R may be sourced from officially registered data sources 66 linking a personal identification number 57 to the rightful purchaser 10R.

As an example it could be officially registered data sources 66 such as the Danish ESR register, which gives information about ownership of a house. Thus, it can give information about whether or not the rightful purchaser 10R has bought a new house or cottage.

The act of updating 220 electronically registered data 60R of the rightful purchaser 10R may be sourced from one or more publicly available data source(s) 67. The data sources could be LinkedIn, Facebook, Instagram, Twitter or the like.

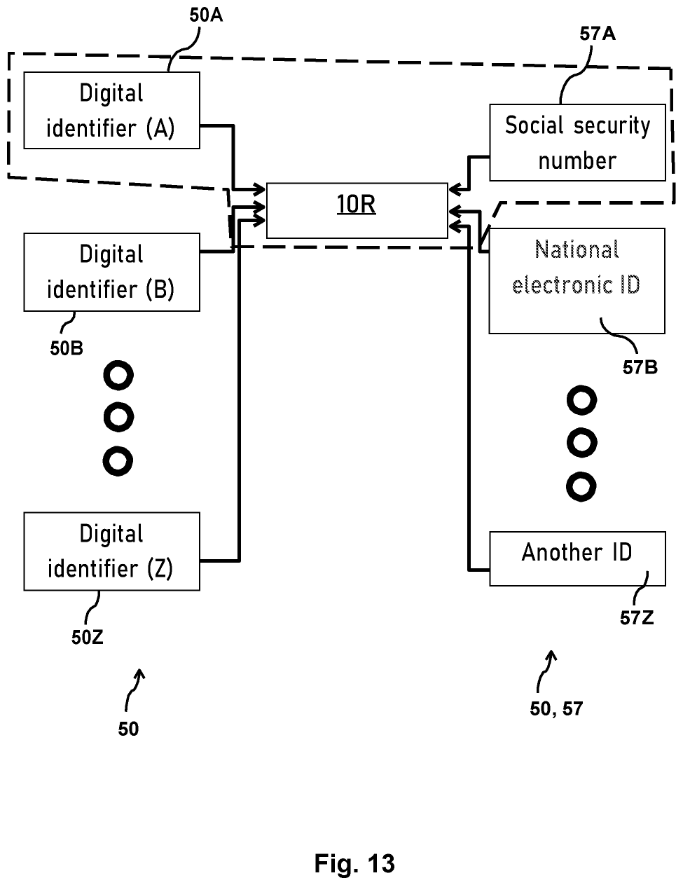

FIG. 13 illustrates the linkage to a rightful purchaser 10R with one or more digital identifiers 50A . . . 50Z and one or more personal identifiers 57A . . . 57Z. In the figure the digital identifier 50A is linked to the rightful purchaser 10R along with the social security number 57A (see dash box).

However, the digital identifier (B) 50B might not be linked to the social security number 57A. It could be that the digital identifier (B) 50B is linked to national electronic ID 57B such as NemID in Denmark.

A digital identifier 50A . . . 50Z may be linked to one or more personal identifiers 57A . . . 57Z and vice versa.

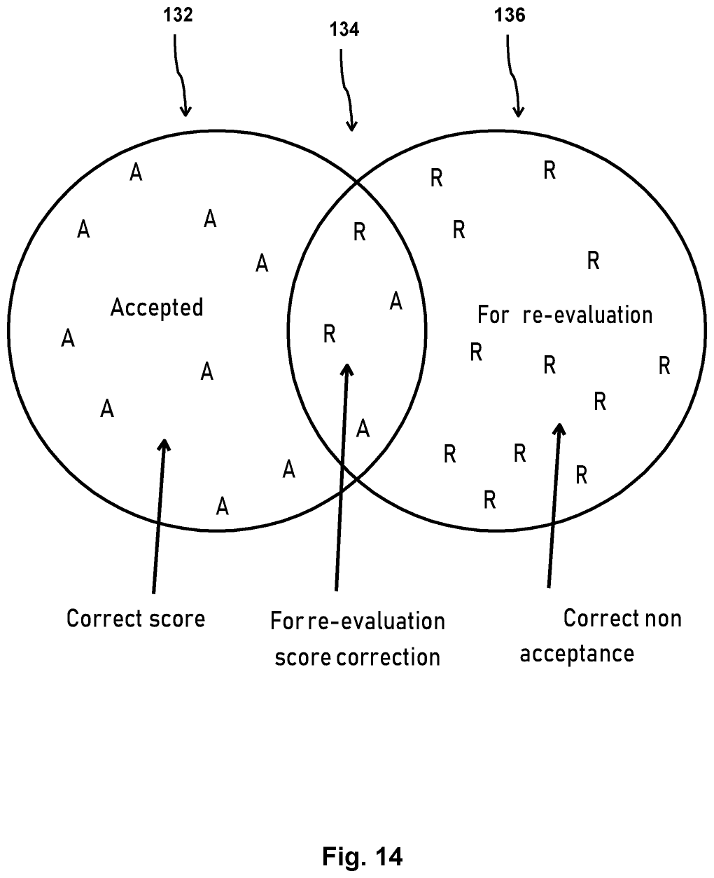

FIG. 14 illustrates the sample space of the method 1000 of estimating likelihood 100. If the likelihood 140 is high enough, the iteration in the method 1000 of estimating likelihood 100 is stopped and the order is taken by the merchant 20.

If the likelihood 140 is below a threshold the iteration in the method 1000 of estimating likelihood 100 is continued as seen in FIG. 7. At a certain iteration step estimating likelihood 100 is stopped, and the transaction 1 is deemed to be inconclusive 136.

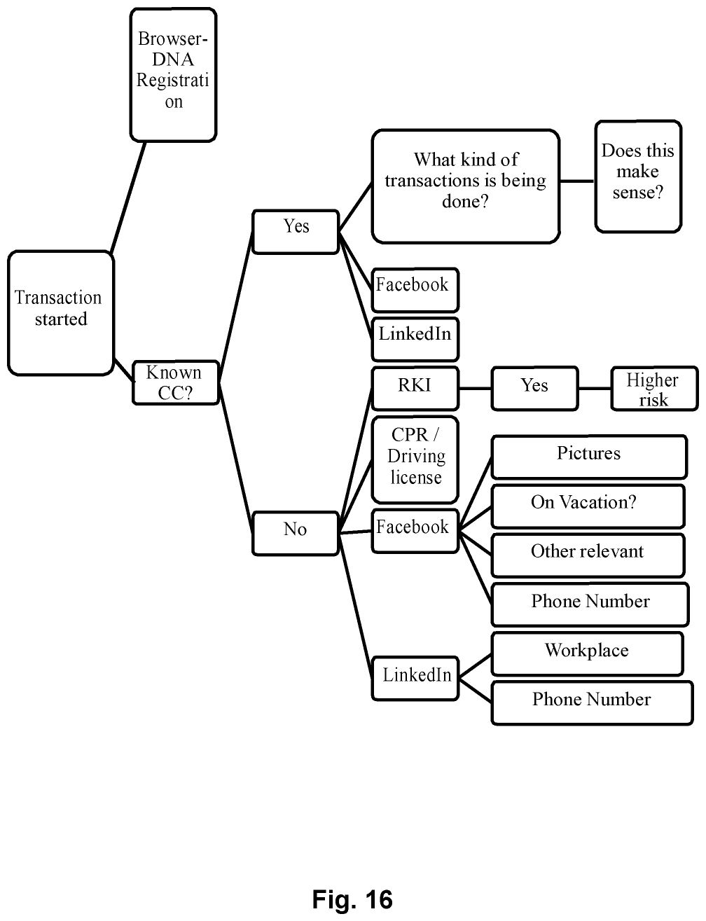

The likelihood 120 is being evaluated both before, with the Browser DNA 70 explained in FIG. 9 and after a transaction processed as seen in FIG. 16. When the transaction is being initialized, the initial likelihood is being determined based data from FIG. 5 60A. If these data on the alleged purchaser 60A in the likelihood is inconsistent with the electronically registered data 60R, the transaction 1 is set for request of data only known by rightful purchaser 60R. These data is to be fulfilled when the transaction is to be processed.

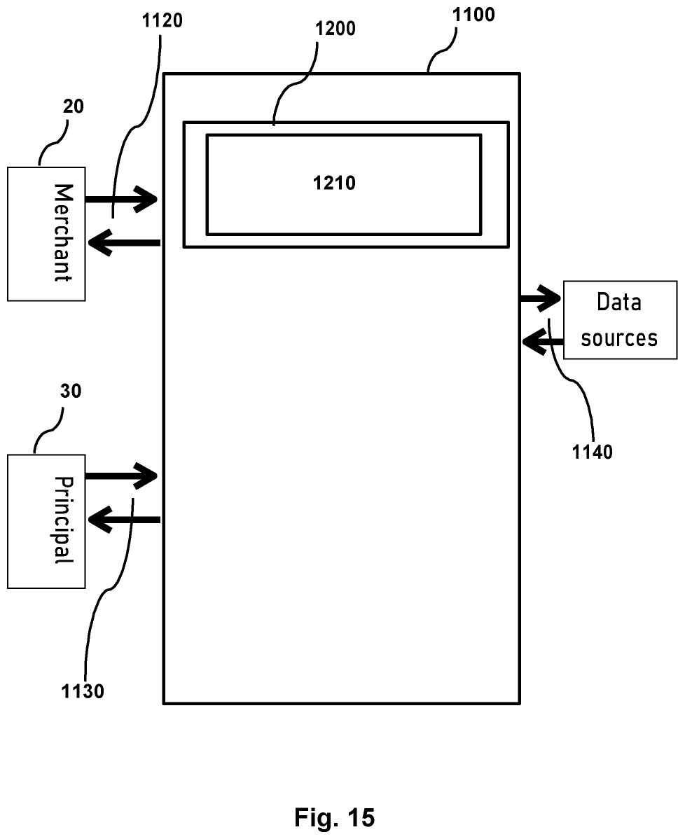

FIG. 15 illustrates a system 1100 for estimating likelihood 120 of an alleged purchaser 10A being the rightful purchaser 10R in an ongoing electronic commerce transaction 1 between a merchant 20 and the alleged purchaser 10A. The transaction 1 is based on a digital identifier 50. The system 1100 comprises the following features.

There is a merchant interface 1120 to exchange data with a merchant 20. There is a principal interface 1130 to exchange data with a principal 30.

There is a collection interface 1140 for providing 200 electronically registered data 60R of the rightful purchaser 10R associated with the digital identifier 50 and collecting 300 electronically registered data 60A of the alleged purchaser 10A using the digital identifier 50 in the transaction 1.

There is a computer 1200 configured for estimating 400 the likelihood 120 as a function 110 of the collected electronically registered data 60A of the alleged purchaser 10A and the provided electronically registered data 60R of the rightful purchaser 10R.

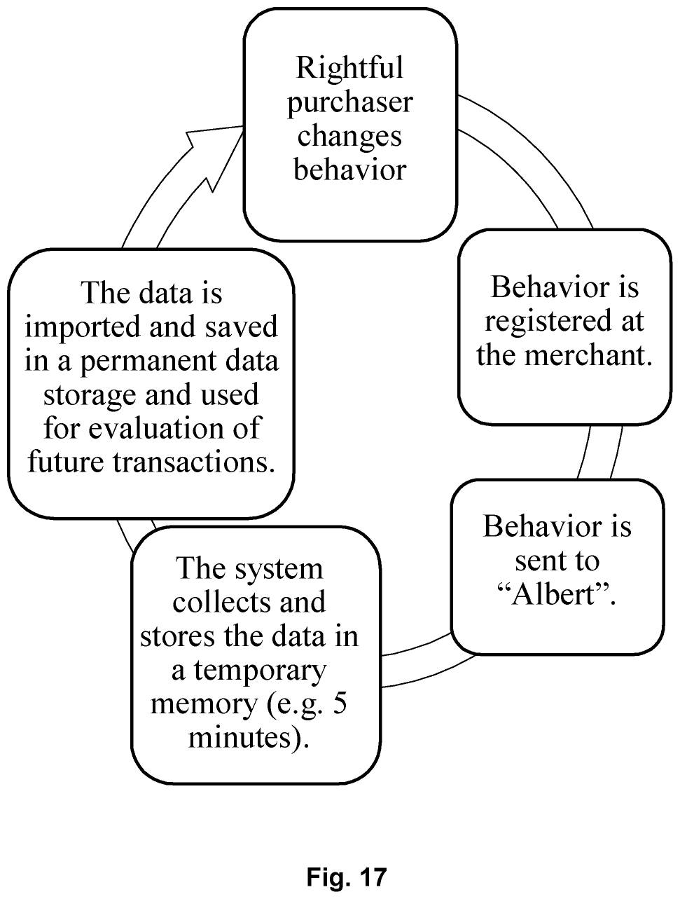

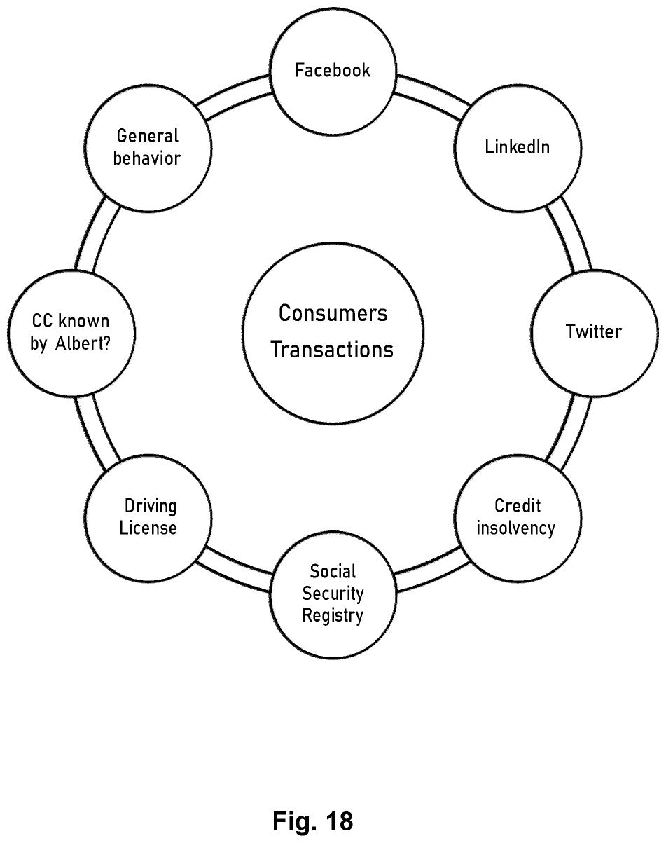

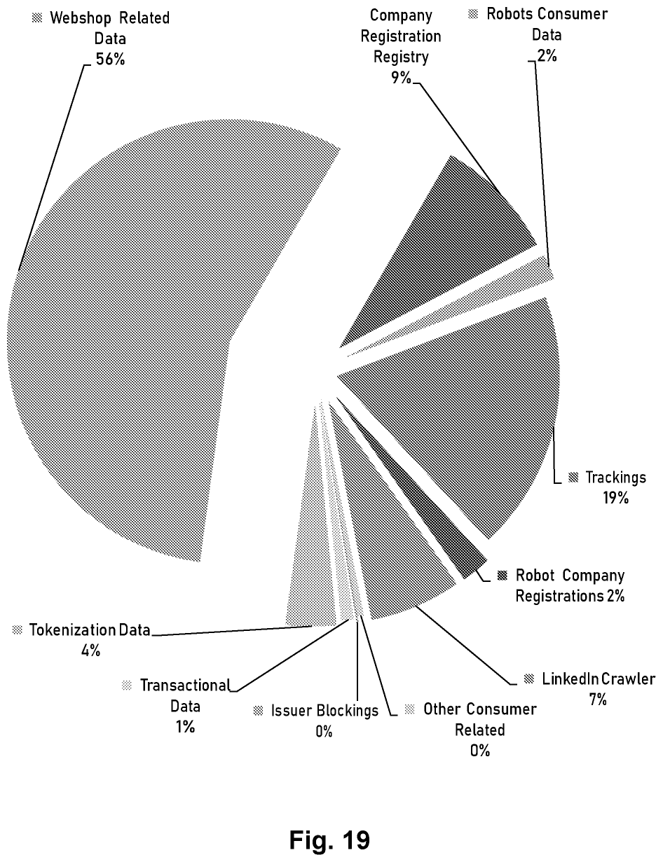

FIGS. 16 to 19 illustrate an example of an implementation.

The disclosed methodology and systems may be implemented as artificial intelligence that is designed to prepare and estimate risks across electronic transactions and if high risk is estimated at the transaction also to inquire the purchaser (the consumer) a list of security questions.

Such methodology or system implementation will hereafter be referred to as “Albert” to reflect the practice in the technical field to nick-name intelligent computer implemented inventions. Dr. Watson of IBM, without comparison, is just one example of such practice.

As such “Albert” is a collection of algorithms implemented on one or more computational devices that are interfaced with other systems. The coding allows for interaction and actions depending on the input. In certain aspects, Albert is autonomous.

A payment receiver, or merchant, indicates the receipt of the payment from the alleged purchaser, this could be a Web-shop, a physical shop or other kind of service and/or private person.

The purchaser indicates himself as sender and fills in the order and payment information.

In connection with every single transaction in an electronic platform, to which Albert is connected, Albert collects a list of user and consumer, the alleged purchaser or the rightful purchaser, related data. In the platform Albert collects the order address of the consumer, delivery address, IP-address, connected Facebook address, ordered products and also a list of further data, which all platforms automatically collect about the consumer. In connection with the payment transaction a timer may automatically register a start of payment and the connecting pattern connected with the behaviour of the consumer.

FIG. 16 illustrates an example of such data collection by Albert, where the data sources are in a Danish context, where RKI is a credit evaluation service, and CPR is a unique Central Person Register (“Social Security Number”).

When the consumer goes through the payment sequence a number of information is further registered about the consumer. This could be typing behaviour and typing pattern, which gives indications about to what extent the consumer actively has typed the information in question or an automatic or deviant behaviour is used in order to fill in the payment sections.

Furthermore, there may be a list of hidden action buttons at the payment pages which only computers can see and interact on. If one of those is activated the payment transaction will flagged to be refused and cannot be accomplished.

When a payment is finally initiated Albert collects all information, estimates the probability of a consumers shopping pattern and in case it is estimated that it is not realistic, Albert will automatically begin asking the consumer questions before the payment transaction is accomplished.

The consumer may be asked a maximum of, e.g. three, questions and if one or more questions answered incorrect there may finally be sent a SMS to a registered and verified number of the rightful consumer or in other way chosen by the card issuer, confirmation is asked for in a legitimate access to the card information.

In connection with the legitimate access to the card information is confirmed by the consumer, the economic responsibility is transferred from the payment receiver, the merchant, to the purchaser, the rightful purchaser.

Albert may also be configured to perform data collection in connection with “physical” shopping. Here Albert will only collect information which later on can be used for estimation.

The calculation or estimation is prepared across the payment receivers and the purchasers.

In connection with every single transaction Albert tries to make a match to Facebook, LinkedIn, Twitter and other digital services where the purchasers are registered. If a match is found, this will be registered at the payment card in preparation for using the digital fingerprint later for a risk calculation of the use of the payment card.

See FIG. 16 for illustration of a data tree.

If the browser's DNA registration is recognized it will be used again in order to see if it matches the new transaction which is about to take place with the payment card.

The browser's DNA is evaluated out from a list of computer specific information, e.g. which printing types are installed, the browser's ID no. and so on.

If the purchaser has been in contact with Albert earlier, Albert will evaluate which type of MCC codes the purchaser normally uses—e.g. if a purchaser normally shops children's wear, it will not (necessarily) make sense if the card is used at an online casino a few hours later.

If the purchaser usually is shopping in the beginning of the month and we several times have noted that the purchaser not has cover from the middle of the month, but tries to make a payment or a notification of debt collection, this will also automatic release a higher risk assessment.

The payment pattern of the consumer is thereby immediately broken—in spite of that it can actually be honestly.

The risk assessment in connection with the purchaser's delivery address is calculated in the light of the stated information in the order and also what is registered at services like LinkedIn, Facebook, Twitter and so on.

If the consumer has an address in Aarhus, but wants the products delivered in Copenhagen, it is evaluated whether we can identify an action which identifies that the consumer has connection to Copenhagen, this could for example be verified as the consumer is employed in a company with headquarters in Copenhagen.

When a purchaser has an objection to a transaction and hand it over to his bank, it is registered in our platform and the area in which the purchaser lives is increased in the risk assessment and also the browser's DNA is registered as problematic.

In connection with the accomplishment of the payment it is tried across all registered data to identify an action pattern which verifies the identity of the purchaser and an occasion to make the action.

If Albert in the beginning has accepted the transaction, the card issuer will be asked for identification of the card information provided that the card information is identical with Albert's registration; and the payment transaction is accepted.

Albert has seen legitimate orders made by a purchaser at holiday destinations, and Albert has not refused the transaction because the purchaser has requested the products delivered at his home address.

Albert has experienced a significant drop of 98% in number of attempts where card information is abused as is estimated to be in the period before the test of Albert.

The last 2% which is a “false positive” test, a number of the consumers are going through the questions and their payment pattern is registered as being correct.

By using Albert, a more secure payment service and a reduction in number of cases with abuse is achieved. This will be of value since credit card theft and information is increasingly seen to happen. For example credit cards are sold at The Dark Web.

In particular Albert has achieved to combine the consumer made data sources, electronic data sources and browser based identifications (browser DNA) in one whole profile which can be used to ensure the payment receiver and the purchaser in the best way against inconveniences.

The use of Albert can ensure the consumers a more smooth transaction when digital media are used.

In connection with countries that allows (written) signatures as verification on card payments, Albert can similar to this ensure shops against manipulation with stolen payment cards and in this way verify if a transaction is realistic; that it is the rightful purchaser who makes the purchase.

What is claimed is:

1. A method of estimating likelihood of an alleged purchaser being a rightful purchaser in an ongoing electronic commerce transaction between a merchant and the alleged purchaser, the method comprising the following steps:
providing electronically registered data of the rightful purchaser associated with a digital identifier;
collecting electronically registered data of the alleged purchaser using the digital identifier in the transaction; and
estimating the likelihood as a function of the collected electronically registered data of the alleged purchaser and the provided electronically registered data of the rightful purchaser.

2. The method of claim 1, wherein the act of collecting electronically registered data of the alleged purchaser includes requesting data based on the electronically registered data of the rightful purchaser from the alleged purchaser.

3. The method of claim 1, wherein the acts of collecting electronically registered data of the alleged purchaser and estimating the likelihood of the alleged purchaser being the rightful purchaser are performed iteratively one or more times, during the one or more iterations, the likelihood is partitioned as:
the transaction is accepted where the alleged purchaser is identified as the rightful purchaser and the iterations are stopped;
the transaction is for re-evaluation where the alleged purchaser is expected to be the rightful purchaser and the iterations are continued;
the true identity of the alleged purchaser is considered inconclusive where the alleged purchaser cannot be determined to be the rightful purchaser and the iterations are stopped.

4. The method of claim 3, wherein the step of estimating the likelihood of the alleged purchaser being the rightful purchaser is only partitioned as inconclusive where the alleged purchaser cancels the ongoing electronic commerce transaction.

5. The method according to claim 1, wherein the step of collecting electronically registered data includes collecting digital identifier-DNA.

6. The method according to any one or more of claims 1 to 5, wherein the step of collecting electronically registered data includes collection of a person-browser-DNA of the alleged purchaser, a software implemented interface-browser-DNA used by the alleged purchaser or collecting both.

7. The method according to claim 6, wherein the collection of person- and/or interface-browser-DNA includes collecting one or more browser setting(s) or browser-pattern(s).

8. The method according to claim 1, wherein in response to the digital identifier being known,
the step of estimating the likelihood of the alleged purchaser being the rightful purchaser is based on stored historical transactions previously performed by the rightful purchaser.

9. The method according to claim 1, wherein in response to the digital identifier being known,
updating the electronically registered data of the rightful purchaser associated with the digital identifier based upon updated status data of the rightful purchaser.

10. The method according to claim 9, wherein the step of updating the electronically registered data of the rightful purchaser is sourced from personal data sources of the rightful purchaser.

11. The method according to claim 9, wherein in response to the digital identifier being unknown,
updating the electronically registered data of the rightful purchaser associated with the digital identifier.

12. The method according to claim 10, wherein the personal data sources are sourced from officially-registered data source(s) linking a personal identification number to the rightful purchaser.

13. The method according to claim 10, wherein the personal data sources are sourced from one or more publicly available data source(s).

14. A method of performing an ongoing electronic commerce transaction between a merchant and an alleged purchaser wherein the transaction is based on a digital identifier linked to a principal verifying the transaction for completion by the merchant; the method comprising the following step:
the alleged purchaser passing the digital identifier to a system for estimating likelihood of the alleged purchaser being a rightful purchaser in the ongoing electronic commerce transaction;
wherein the system for estimating likelihood performs the following steps:
registering the digital identifier and the transaction,
providing electronically registered data of the rightful purchaser associated with the digital identifier,
collecting electronically registered data of the alleged purchaser using the digital identifier in the transaction,
estimating the likelihood as a function of the collected electronically registered data of the alleged purchaser and the provided electronically registered data of the rightful purchaser,
passing the digital identifier and the transaction to the principal for verification of the transaction based on the digital identifier, and
receiving a transaction verified or a transaction un-verified from the principal; and
in response to receiving transaction verified, the system for estimating likelihood performs the following steps
passing the estimated likelihood as transaction is for acceptance to the merchant;
storing electronically registered data of the alleged purchaser as electronically registered data of the rightful purchaser
in response to receiving transaction un-verified, the system for estimating likelihood to perform the following steps
requesting one or more verification requirements as further documentation of the alleged purchaser being the rightful purchaser;
passing the estimated likelihood as transaction is for acceptance or transaction is for re-evaluation or transaction is considered inconclusive to the merchant;
in response to the system for estimating likelihood passing the estimated likelihood and the likelihood partitioned as
Transaction is for acceptance,
Transaction is for re-evaluation, and
Transaction is considered inconclusive
to the merchant and conditionally one or more verification requirements for the transaction to proceed or not.

15. The method according to claim 14, wherein the system for estimating the likelihood is implemented as instructions on a computer.

16. A system for estimating likelihood of an alleged purchaser being the rightful purchaser in an ongoing electronic commerce transaction between a merchant and the alleged purchaser, the transaction being based on a digital identifier, the system comprising:
a merchant interface configured and arranged to exchange data with a merchant;
a principal interface configured and arranged to exchange data with a principal;
a collection interface configured and arranged to
provide electronically registered data of the rightful purchaser associated with the digital identifier, and
collect electronically registered data of the alleged purchaser using the digital identifier in the transaction; and
a computer configured and arranged for estimating the likelihood as a function of the collected electronically registered data of the alleged purchaser and the provided electronically registered data of the rightful purchaser.

17. A computer program comprising instructions to cause the computer of claim 16 to execute the steps of claim 14.
